(19) United States
(12) Patent Application Publication
(10) Pub. No.: US 2014/0184389 A1
(43) Pub. Date: Jul. 3, 2014

(54) ELECTRONIC DEVICE AND DEVICE CONTROL METHOD

(71) Applicant: Kabushiki Kaisha Toshiba, Tokyo (JP)

(72) Inventor: Yosuke Takahashi, Kokubunji (JP)

(73) Assignee: KABUSHIKI KAISHA TOSHIBA, Tokyo (JP)

(21) Appl. No.: 14/013,837

(22) Filed: Aug. 29, 2013

Related U.S. Application Data
(63) Continuation of application No. PCT/JP2013/058382, filed on Mar. 22, 2013.

(30) Foreign Application Priority Data
Dec. 27, 2012 (JP) 2012-286089

(51) Int. Cl. G08C 17/00; H04L 29/12

(52) U.S. Cl. CPC G08C 17/00; H04L 61/2007
USPC 340/9.16; 340/12.53

(57) ABSTRACT

According to one embodiment of the present disclosure, an electronic device comprises a storage unit, a determination unit, controller, and a communication unit. The storage unit stores pieces of registration information including information concerning a target device and information concerning a direction of the target device. The determination unit detects a first direction of this electronic device. The controller selects one piece of first registration information from the pieces of registration information based on the first direction and sets a first target device based on selected information. The communication unit transmits a control signal that is used for controlling the first target device.

### CROSS REFERENCE TO RELATED APPLICATIONS

This application is a Continuation Application of PCT Application No. PCT/JP2013/058382, filed Mar. 22, 2013 and based upon and claiming the benefit of priority from Japanese Patent Application No. 2012-286089, filed Dec. 27, 2012, the entire contents of all of which are incorporated herein by reference.

### FIELD

Embodiments described herein relate generally to an electronic device and a device control method.

### BACKGROUND

A technology of controlling devices by one remote controller has been suggested. For example, a user can control (operate) a TV set by using a remote controller and display a device selection screen on a TV screen. If a recorder is connected to the TV, the user can select the recorder through the device selection screen by using the remote controller, and then the user can control (operate) the recorder with the same remote controller.

As described above, devices can be controlled by one remote controller, but the operation is complicated, and improvement has been demanded. For example, when frequently changing a target device is desired, it can be expected that the operation becomes more complicated.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a view showing an example of device control executed by an electronic device control system according to a first embodiment;

FIG. 2 is a view showing an example of an outline configuration of the electronic device control system according to the first embodiment;

FIG. 3 is a view showing an example of a registration screen displayed by a registration UI according to first and second embodiments;

FIG. 4 is a view showing an example of an inclination and direction registration screen displayed by the registration UI according to the first and second embodiments;

FIG. 5 is a view showing a first example of an operation screen displayed by the operation UI according to the first and second embodiments;

FIG. 6 is a view showing a second example of the operation screen displayed by the operation UI according to the first and second embodiments;

FIG. 7 is a view for explaining a target device determination method performed by a determination unit according to the first and second embodiments;

FIG. 8 is a view showing an example of device control executed by an electronic device control system according to a second embodiment; and

FIG. 9 is a view showing an example of an outline configuration of the electronic device control system according to the second embodiment.

### DETAILED DESCRIPTION

Various embodiments will be described hereinafter with reference to the accompany drawings.

In general, according to one embodiment, there are provided an electronic device, a device control method, and a device control program that enable easily setting a target device and controlling the target device.

According to an embodiment of the present disclosure, an electronic device that controls a target device comprises storing module, detector, controller, and communicator. The storing module stores pieces of registration information including information concerning a target device and information concerning a direction of the target device. The detector detects a first direction of this electronic device. The controller selects one piece of first registration information from the pieces of registration information based on the first direction and sets a first target device based on information concerning the target device included in the first registration information. The communicator transmits a control signal that is used for controlling the first target device.

An embodiment will further be described with reference to the drawings.

First and second embodiments will now be described hereinafter with reference to the drawings.

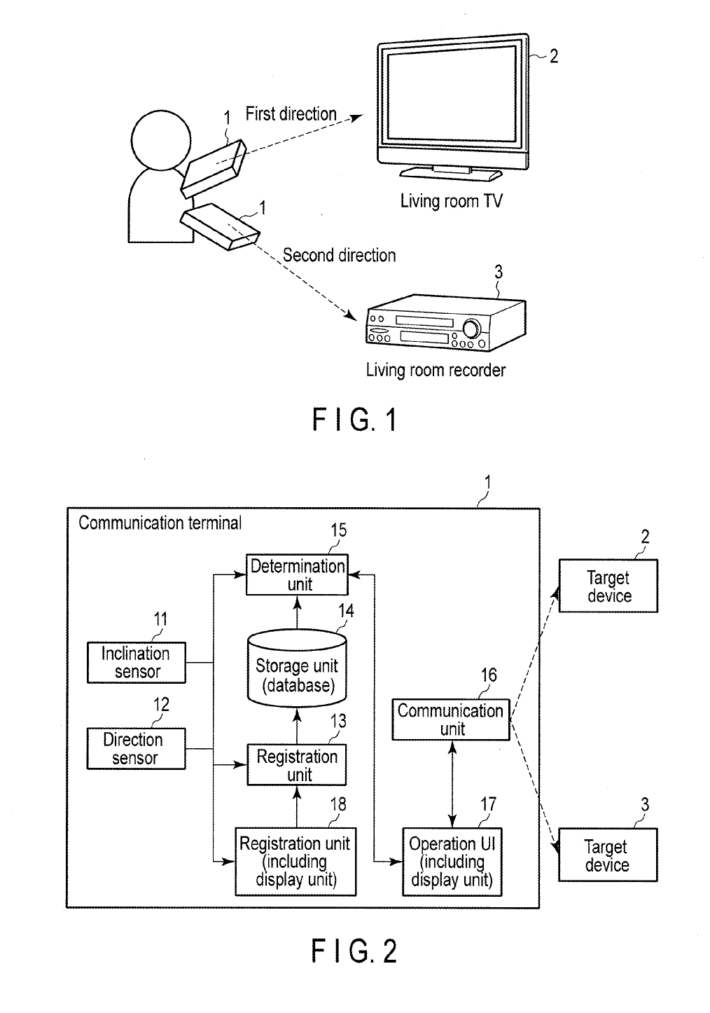

FIG. 1 is a view showing an example of device control performed by an electronic device control system according to a first embodiment. FIG. 2 is a view showing an outline configuration of the electronic device control system according to the first embodiment.

As shown in FIG. 1 and FIG. 2, the electronic device control system is constituted of a communication terminal (an electronic device) 1, a target device 2, and a target device 3. For example, the communication terminal 1 can control one or more target devices connected through a common electronic network.

For example, the communication terminal 1 is a mobile phone, a smartphone, a personal computer (a tablet personal computer), or a remote controller. Furthermore, for example, the target device 2 is a living room TV (TV), and the target device 3 is a living room recorder (recorder).

In the first embodiment (and a second embodiment), a description will be given as to a case where one communication terminal 1 select one of the two target devices 2 and 3 and controls it, but the control explained in the first embodiment (and the second embodiment) can be applied to a case where one communication terminal 1 control one or more target devices. Moreover, the target device 2 and the target device 3 may be or may not be connected to each other.

In the first embodiment, for example, it is assumed that a user uses the communication terminal 1 and controls (operates) the target device 2 or 3 at the same position. When the communication terminal 1 is directed toward the target device 2 or 3 by the user, the communication terminal 1 sets the target device 2 or 3 as a control target. That is, the user can easily control the target device 2 or 3 by just directing the communication terminal 1 toward the target device 2 or 3, and hence a burden on the user can be alleviated.

Additionally, the communication terminal 1 can select a three-dimensional target device, and it can cope with a positional relationship of the target devices that can be vertically arranged like the target device 2 and the target device 3 that are placed in, e.g., a rack.

As shown in FIG. 2, the communication terminal 1 comprises an inclination sensor 11, a direction sensor 12, a registration unit 13, a storage unit (a database) 14, a determination unit 15, a communication unit 16, an operation UI 17, and a registration UI 18.

The inclination sensor 11 functions as detector for detecting an inclination (a value) of an apparatus (the communication terminal 1), measures an inclination degree of the communication terminal 1 from the horizontal direction, and outputs a measured value. Additionally, the direction sensor 12 functions as detector for detecting a direction (a value) of the apparatus (the communication terminal 1), measures a degree of a direction of the communication terminal 1 from a reference direction, and outputs a measured value. This embodiment shows an example where a direction of the communication terminal 1 is identified (detected) from two factors, i.e., an inclination degree (an inclination) of the communication terminal 1 from the horizontal direction and a degree of a direction of the communication terminal 1 from the reference direction, but the present invention is not restricted thereto. A direction of the communication terminal 1 is identified (detected) by an arbitrary method.

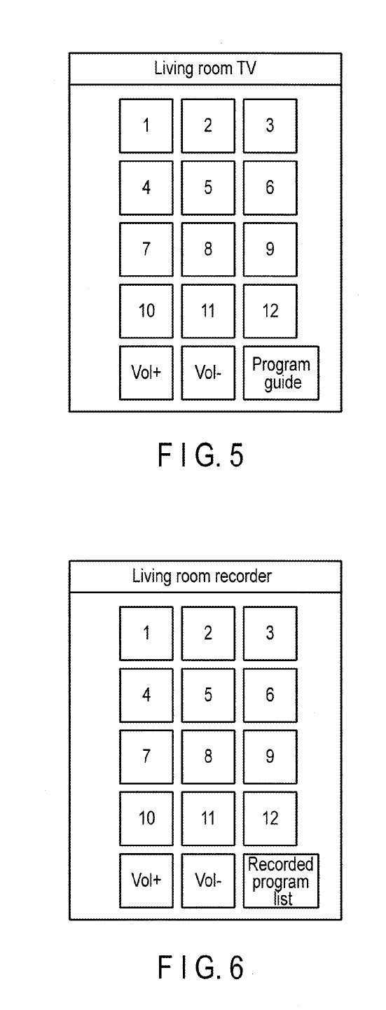

The registration unit 13 is a module that stores information of a target device (a target device name, an IP address (device intrinsic information), and others), a value (an inclination) detected by the inclination sensor 11, and a value (a direction) detected by the direction sensor 12 in the database in association with each other. For example, the registration unit 13 registered (stores) first and second registration information in the database, the first registration information includes device information (a target device name, an IP address), inclination information (a registered inclination value), and direction information (a registered direction value) of the target device 2, and the second registration information includes device information (a target device name, an IP address), inclination information (a registered inclination value), and direction information (a registered direction value) of the target device 3. The storage unit 14 stores the database. The storage unit 14 stores display information required for displaying an operation screen for the target device 2 (FIG. 5) and display information required for displaying an operation screen for the target device 3 (FIG. 6).

The determination unit 15 is a module that functions as controller and selects one piece of registration information from one or more pieces of registration information registered in the database based on a current inclination (a detected inclination value) detected by the inclination sensor 11 and a current direction (a detected direction value) detected by the direction sensor 12. As described above, since each registration information includes information concerning a direction constituted of the registered inclination value and the registered direction value, the determination unit 15 compares the detected inclination value with the registered inclination value included in each registration information, also compares the detected direction value with the registered direction value included in each registration information, and comprehensively selects the registration information which is the closest to the detected direction value and the detected direction value based on these comparison results. That is, the determination unit 15 selects the registration information of the target device which is in a direction that is the closest to the direction toward which the apparatus (the communication terminal 1) faces.

The communication unit 16 is a module that communicates with the target device 2 or 3. For example, the communication unit 16 can transmit information to the target device 2 or 3 or receive information from the target device 2 or 3 based on communication such as TCP-IP. Additionally, the communication unit 16 can communicate with an external server and receive various kinds of information (e.g., commands dedicated to the target device 2 or 3, display information required for displaying an operation screen) concerning the target device 2 or 3 based on the communication, e.g., TCP-IP. For example, the communication unit 16 can transmit an operation instruction (a command) associated with an operation input by a user through the operation UI 17 to the designated target device 2 or 3. The target device 2 or 3 receives a command (a control signal) transmitted from the communication terminal 1 based on the communication, e.g., TCP-IP and executes an operation associated with the command.

It is to be noted that a description will be given as to a case where the communication terminal 1 communicates with the target device 2 or 3 by utilizing TCP-IP or the like, but a cellular system utilized for mobile phones and others may be used, Bluetooth (a registered trademark) may be used, or infrared communication may be used.

The registration UI 18 is a user interface configured to register information of a target device (a target device name, an IP address (device intrinsic information), and others), a value (an inclination) detected by the inclination sensor 11, and a value (a direction) detected by the direction sensor 12 in the database in association with each other. For example, the registration UI 18 is constituted of a display control unit that controls display of a registration screen or the like based on display information, a display unit that displays a registration screen or the like, and an input acceptance unit (e.g., a touch panel) that accepts input of an operation from a user. The input acceptance unit is provided in accordance with the display unit and detects input (pressing) associated with each of various buttons displayed in the display unit.

The operation UI 17 is a user interface that accepts an operation input from a user and instructs to transmit a command associated with the operation input. For example, the operation UI 17 is constituted of a display control unit, a display unit, and an input acceptance unit (e.g., a touch panel). The input acceptance unit is provided in accordance with the display unit and detects input (pressing) associated with each of various buttons displayed in the display unit. The communication unit 16 transmits a command based on a command transmitting instruction.

A description will now be individually given as to (a) a registration phase and (b) an operation phase.

(a) Registration Phase

In the registration phase, the registration unit 13 registers information of a target device in the database. The information of a target device is information required for control (an operation) over the target device and includes, e.g., an IP address, an MAC address, a port number, and others, and an ID or a password is included if authentication is required.

A technique for urging a user to input such information may be any method as long as such information can be acquired and, for example, a method by which a user directly inputs information in a test input form displayed by the registration UI 18 may be used.

Further, it is possible to adopt a method by which the communication unit 16 automatically detects target devices present on the same electronic network (automatically receives information of target devices), the registration UI 18 displays a list of the detected target devices, and a user selects a device to be registered from the list of the target devices through the registration UI 18. When the user selects a device to be registered from the list of the target devices through the registration UI 18, information of the device to be selected is registered. For example, there is a method of acquiring information of a target device by using a digital living network alliance (DLNA). In case of acquiring information of a target device by the communication unit 16, the user's work for inputting the information can be greatly alleviated.

Furthermore, in the registration phase, the registration unit 13 registers an inclination detected by the inclination sensor 11 and a direction detected by the direction sensor 12 when the apparatus (the communication terminal 1) is directed toward a target device. That is, the registration unit 13 registers an inclination detected for registration (a registered inclination value) and a direction detected for registration (a registered direction value) in association with the information of a target device acquired as described above,

For example, the registration phase is carried out in the following order.

(1) The user starts up the registration UI 18 (the registration UI 18 displays a registration screen).

(2) The user inputs information required for registration through the registration screen.

(3) The user press a complete button in the registration screen.

(4) The registration UI 18 displays an inclination and direction registration screen.

(5) The registration UI 18 displays values of the inclination sensor 11 and the direction sensor 12 on the inclination and direction registration screen. The values of the inclination sensor 11 and the direction sensor 12 are periodically updated in accordance with an inclination and a direction of the communication terminal 1.

(6) The user turns the communication terminal 1 toward the target device and presses the register button. It is to be noted that the communication terminal 1 does not have to be actually turned to face the target device, and turning the communication terminal 1 toward a predetermined direction and pressing the register button can suffice. In the later-described operation phase, when the communication terminal 1 is turned toward the predetermined direction, the target device can be controlled.

(7) The registration unit 13 registers the information of the target device, the inclination detected by the inclination sensor 11, and the direction detected by the direction sensor 12 in the database.

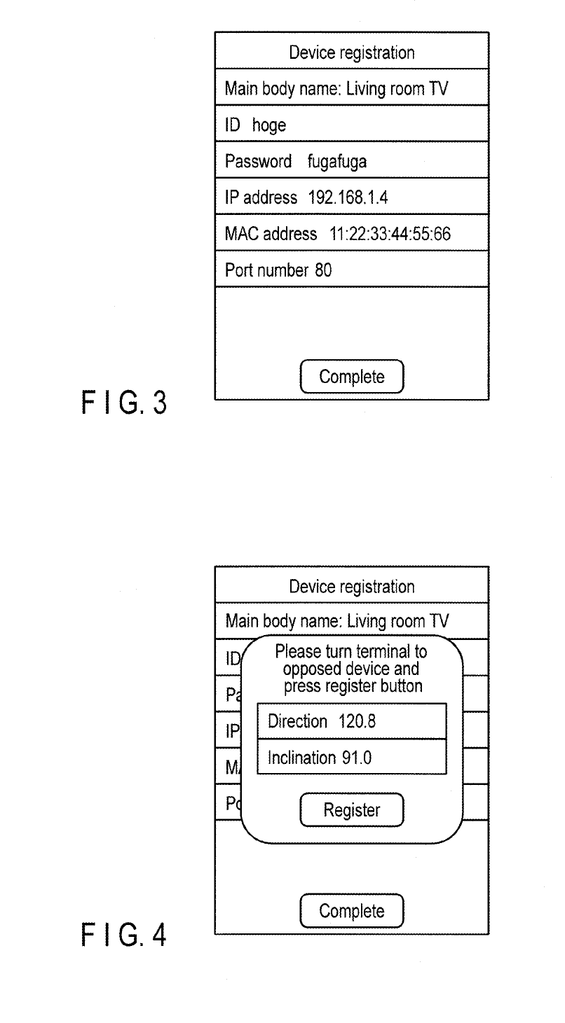

FIG. 3 is a view showing an example of the registration screen displayed by the registration unit UI 18, and FIG. 4 is a view showing an example of the inclination and direction registration screen displayed by the registration UI 18. It is to be noted that FIG. 4 is a view showing an example that the inclination and direction registration screen is displayed on the registration screen.

The user can input the information of the target device through the registration screen shown in FIG. 3. When the input is finished, the input of the information of the target device can be completed by pressing a “complete” button provided at the lowermost part. It is to be noted that, in case of receiving the information of the target device by the communication unit 16 as described above, the registration screen shown in FIG. 3 is likewise displayed, and the input of the information of the target device can be completed by pressing the “complete” button provided at the lowermost part.

The inclination and direction registration screen shown in FIG. 4 displays a current inclination detected by the inclination sensor 11 and a current direction detected by the direction sensor 12. In a state that the user turns the communication terminal 1 toward a desired direction (in a state that the communication terminal 1 is turned toward the target device to be registered), when a “register” button provided at the lowermost part in the inclination and direction registration screen is pressed, the inclination and the direction displayed in the inclination and direction registration screen are registered in the database together with the information of the target device.

For example, when the user registers the information of the target device 2 through the registration screen shown in FIG. 3, turns the communication terminal 1 toward the direction (a first direction) of the target device 2 as shown in FIG. 1 while the inclination and direction registration screen is displayed, and presses the “register” button in the inclination and direction registration screen, the information of the target device 2 and the direction from the communication terminal 1 and the target device 2 are registered in association with each other. Likewise, when the user registers the information of the target device 3 through the registration screen shown in FIG. 3, turns the communication terminal 1 toward the direction (a second direction) of the target device 2 as shown in FIG. 1 while the inclination and direction registration screen is displayed, and presses the “register” button in the inclination and direction registration screen, the information of the target device 3 and the direction from the communication terminal 1 toward the target device 3 are registered in association with each other.

(b) Operation Phase

In the operation phase, a command is transmitted to a target device. When the target device is a television set, the command is, e.g., a channel change instruction. When the user presses a button in the operation screen displayed by the operation UI 17, the operation UI 17 instructs to transmit a command associated with the pressed button, and the communication unit 16 transmits the command.

For example, when the user turns the communication terminal 1 toward the first direction, the determination unit 15 selects first registration information from detection results of the inclination sensor 11 and the direction sensor 12, sets the target device 2 as a control target based on the first registration information, and transmits a command for controlling the target device 2. As a result, for example, when the user just turns the communication terminal 1 toward the first direction, a power-on command can be transmitted to the target device 2, and the target device 2 can be activated.

Alternatively, when the user turns the communication terminal 1 toward the first direction, the determination unit 15 selects the first registration information from detection results of the inclination sensor 11 and the direction sensor 12 and sets the target device 2 as a control target based on the first registration information, the operation UI 17 displays the operation screen used for operating the target device 2, the user presses a button on the operation screen, then the operation UI 17 instructs to transmit a command associated with the pressed button (a command for controlling the target device 2), and the communication unit 16 transmits the command. For example, when the user presses a button of a channel 1, the target device 2 switches a current channel to the channel 1. As a result, for example, when the user just turns the communication terminal 1 toward the first direction and presses the button, the target device 2 can be operated.

That is, the target device can be controlled by just turning the communication terminal 1 toward the target device or turning the communication terminal 1 toward the target device and pressing a button on the operation screen. Even if target devices are present on the same network, a desired target device can be controlled.

For example, the operation phase is carried out in the following order.

(1) The user starts up the operation UI 17.

(2) The operation UI 17 sets a target device and displays the operation screen associated with the target device.

(3) The operation UI 17 changes the target device in accordance with a current direction of the apparatus and updates the operation screen. The target device 2 is set as a target device and the operation screen (see FIG. 5) associated with the target device 2 is displayed when the communication terminal 1 is turned toward the first direction, and the target device 3 is set as a target device and the operation screen (see FIG. 6) associated with the target device 3 is displayed when the communication terminal 1 is turned toward the second direction.

(4) The user turns the communication terminal 1 toward the direction of the target and presses a button on the operation screen displayed by the operation UI 17.

(5) The operation UI 17 instructs to transmit a command associated with the set target device. For example, the command includes information of the target device (an IP address) and common command information (or dedicated command information). In this case, since this command includes the information of the target device (the IP address), this command is received by a target device identified by the information of the target device (the IP address), and the target device that has received this command operates in accordance with the common command information (or the dedicated command information) included in this command. The common command information is a command that can be used by either the target device 2 or 3, and the dedicated command information is a command that cannot be used by either the target device 2 or 3. Alternatively, the command includes the dedicated command information of the target device but does not include the information of the target device (the IP address). In this case, since this command does not include the information of the target device (the IP address), it is received by target devices, but this command includes the dedicated command information of the target device, and hence only the target device that can interpret this dedicated command information operates in accordance with the dedicated command information included in this command.

(6) The communication unit 16 transmits the command.

FIG. 5 is a view showing an example of the operation screen (the operation screen associated with the target device 2) displayed by the operation UI 17, and FIG. 6 is a view showing an example of the operation screen (the operation screen associated with the target device 3) displayed by the operation UI 17.

As shown in FIG. 5, channel selection buttons and others are arranged on the operation screen (the operation screen associated with the target device 2), a program guide button is arranged, and a target device name (Living Room TV) acquired by the determination unit 15 is displayed at an upper part of the screen. Additionally, as shown in FIG. 6, channel selection buttons and others are arranged in the operation screen (the operation screen associated with the target device 3), a recorded program list is arranged, and a target device name (Living Room Recorder) acquired by the determination unit 15 is displayed at the upper part of the screen.

That is, the operation UI 17 displays the operation screen shown in FIG. 5 (the operation screen associated with the target device 2) when the communication terminal 1 is turned to the first direction, and the operation UI 17 displays the operation screen shown in FIG. 6 (the operation screen associated with the target device 3) when the communication terminal 1 is turned toward the second direction. That is, the operation screen is switched in accordance with each direction to which the communication terminal 1 is turned.

It is to be noted that, in the first embodiment (and the second embodiment), arrangement of channel selection buttons in the operation screen shown in FIG. 5 is the same as that in the operation screen shown in FIG. 6, but the arrangement of channel selection buttons may be changed in accordance with each target device.

A target device determination method performed by the determination unit 15 will now be described.

The determination unit 15 selects a device facing a direction that is the closest to a direction toward which the communication terminal 1 faces as a control target. That is, the determination unit 15 selects registration information indicative of a direction that is the closest to a direction toward which the communication terminal 1 faces and selects a target device associated with device information included in the selected registration information as a control target.

The closest direction is a direction having the smallest angle that is formed between a direction toward which the communication terminal 1 faces and a given direction of the target device (a direction indicated by the registration information). How far the communication terminal 1 is apart from the target device does not have to be taken into consideration.

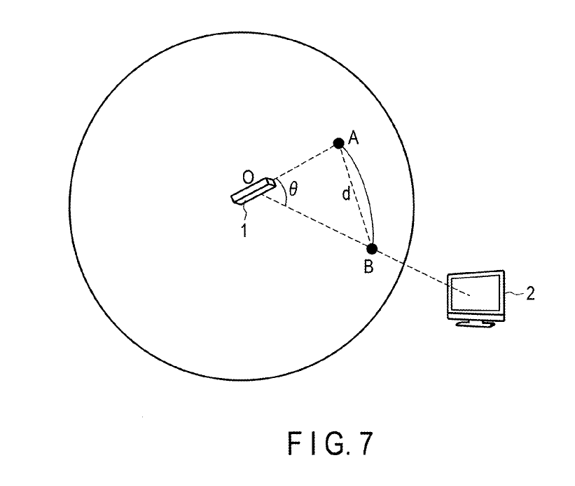

It is assumed that an angle formed between a direction toward which the communication terminal 1 faces and a given direction of the target device is θ (FIG. 7). An xyz coordinate system having a coordinate of the communication terminal 1 as an origin O will now be considered. In a sphere having a radius 1 from O, a straight line is extended in a direction toward which the communication terminal 1 faces, and a spot at which the line intersects with the sphere is determined as A. Further, a spot at which a straight line connecting the target device with O intersects with the sphere is determined as B. Assuming that a distance between A and B is d, the following Expression 1 is achieved.

$$cos θ = 1 - \frac{{d}^{2}}{2} \qquad ( Expression 1 )$$

Since θ is 0°≦θ≦180° and cos θ monotonously decreases with respect to θ in this range, it can be understood that recognizing a magnitude correlation of cos θ can suffice in regard to a magnitude correlation of θ. However, the magnitude correlation of θ is opposite to that of cos θ.

In regard to a coordinate of A, assuming that a value of the direction sensor is α_{A} and a value of the inclination sensor is β_{A}, A can be represented by the following Expression 2.

(cos α_{A} cos β_{A}, sin α_{A} cos β_{A}, sin β_{A}) (Expression 2)

Likewise, in regard to a coordinate of B, assuming that a value of the direction sensor is α_{B} and a value of the inclination sensor is β_{B}, B can be represented by the following Expression 3.

(cos α_{B} cos β_{B}, sin α_{B} cos β_{B}, sin β_{B}) (Expression 3)

Therefore, d can be represented by the following Expression 4.

$$d = \sqrt{2 ( 1 - sin {β}_{A} sin {β}_{B} - cos {β}_{A} cos {β}_{B} cos ( {α}_{A} - {α}_{B} ) )} \qquad ( Expression 4 )$$

Based on (Expression 1) and (Expression 4), a value of cos θ can be obtained.

A value of cos θ is calculated with respect to each target device, a target device that can take the highest value is selected, and the selected target device is set as a control device. That is, a value of cos θ is calculated with respect to each target device, registration information representing the highest value is selected, and a target device is set based on device information included in the selected registration information.

With the above-described operation, a user can control the target device by performing only an intuitive operation, i.e., turning the communication terminal 1 toward the target device. Furthermore, the target device can be selected by taking not only the horizontal direction but also the vertical direction of the communication terminal 1 into consideration.

Although the case where the target device is selected based on an inclination and a direction has been explained above, a global positioning system (GPS) may be further used, and the target device may be selected based on an inclination, a direction, and positional information.

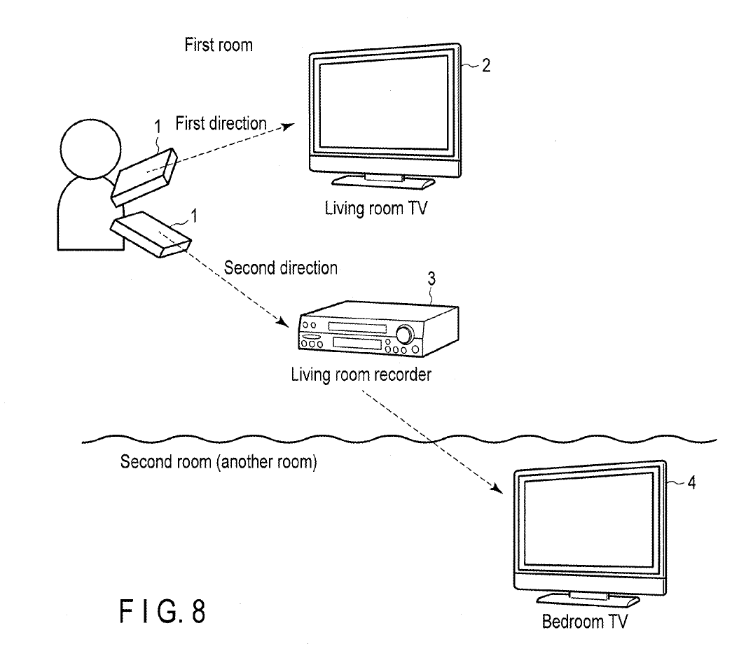

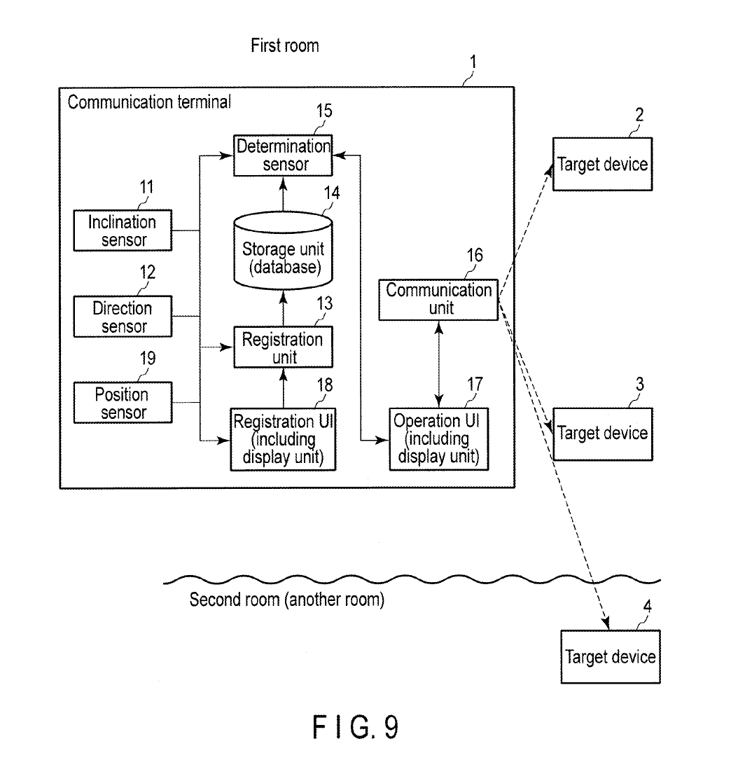

FIG. 8 is a view showing an example of device control effected by an electronic device control system according to a second embodiment. FIG. 9 is a view showing an example of an outline configuration of the electronic device control system according to the second embodiment. In the explanation of the second embodiment, a difference from the first embodiment will be mainly described, and the explanation about points common to the first embodiment will be omitted.

As shown in FIG. 8, a communication terminal 1 comprises a position sensor 19, and a position of the communication terminal 1 (positional information) can be detected by utilizing a GPS. The positional information includes latitude information and longitude information.

As a result, in the registration phase, when a user uses the communication terminal 1 at a predetermined position in a first room (a position associated with positional information A) and registers first registration information associated with a target device 2, the first registration information includes device information (a target device name, an IP address), inclination information (a registered inclination value), direction information (a registered direction value), and positional information (positional information A) of the target device 2. Likewise, when the user uses the communication terminal 1 at the predetermined position in the first room (the position associated with the positional information A) and registers second registration information associated with a target device 3, the second registration information includes device information (a target device name, an IP address), inclination information (a registered inclination value), direction information (a registered direction value), and positional information (positional information B) of the target device 3.

Moreover, in the registration phase, when the user uses the communication terminal 1 at a predetermined position (a position associated with the positional information B) in a second room (another room) and registers third registration information associated with a target device 4, the third registration information includes device information (a target device name, an IP address), inclination information (a registered inclination value), direction information (a registered direction value), and positional information (the positional information B) of the target device 4.

In the operation phase, when the user turns the communication terminal 1 toward the target device 2 at the predetermined position (the position associated with the positional information A) in the first room, the communication terminal 1 selects the first registration information based on an inclination detected by an inclination sensor 11, a direction detected by a direction sensor 12, and a position detected by a position sensor 19, and a determination unit 15 sets the target device 2 associated with the first registration information as a control target. The selected first registration information includes positional information indicative of a position substantially the same as the position detected by the position sensor 19. At this time, even if the target device 3 is present in the same direction as the target device 2 based on the communication terminal 1, the target device 2 is set as a control target in place of the target device 3 by using the positional information.

Additionally, in the operation phase, when the user turns the communication terminal 1 toward the target device 4 at the predetermined position (the position associated with the positional information B) in the second room, the communication terminal 1 selects the third registration information based on an inclination detected by the inclination sensor 11, a direction detected by the direction sensor 12, and a position detected by the position sensor 19, and the determination unit 15 sets the target device 4 associated with the third registration information as a control target. The selected third registration information includes positional information indicative of substantially the same position as the position detected by the position sensor 19.

The first and second embodiments will now be summarized hereinafter.

The communication terminal 1 stores registration information including information of a target device, an inclination of a main body, and a direction of the main body in the registration phase, and the communication terminal 1 detects a predetermined inclination and a predetermined direction, selects the registration information from detection results, and sets a target device based on information of the target device included in the registration information when the main body of the communication terminal 1 is turned to face the predetermined direction at the predetermined inclination in the operation phase. As a result, a user can control the target device by just turning the communication terminal 1 to the predetermined direction at the predetermined inclination, for example. Further, the target device can be switched by just changing the direction of the communication terminal 1.

It is to be noted that all of the control (the registration, the operation, and others) can be executed by software. Therefore, the control can be easily realized by just installing a program that executes a procedure of the control in a regular computer through a computer readable storage medium that stores this program and executing this program.

For example, the communication terminal 1 can read the program from the computer readable storage medium, store the program read in the storage unit 14, and complete installation of the program. Alternatively, the communication terminal 1 can download the program through the communication unit 16 or the like, store the downloaded program in the storage unit 14, and complete installation of the program. As a result, the communication terminal 1 corresponding to the computer can realize the control based on the installed program.

Although the several embodiments according to the present invention have been described, these embodiments are presented as examples, and they are not intended to restrict the scope of the present invention.

In the above descriptions, the term “unit” is in the category of the embodiments even if the term is replaced with “apparatus”, “device”, “block”, module” or “logic”. These embodiments can be carried out in other various conformations, and various kinds of omission, substitution, and change can be effected without departing from the gist of the present invention. These embodiments or modifications are included in the scope or the gist of the present invention and also included in the range equivalent to the invention described in claims.

What is claimed is:

1. An electronic device configured to control target devices, comprising:
storing module configured to store registration information comprising information about each target device and information about a direction of each target device;
detector configured to detect a first direction of the electronic device;
controller configured to select a first target device based on both a relationship between the first direction and a direction of the first target device and information of the first target device; and
communicator configured to transmit a control signal used for controlling the first target device.

2. The electronic device of claim 1, comprising input accepting module for accepting an operation input,
wherein the communicator transmits the control signal used for controlling the first target device based on the operation input accepted by the input accepting module.

3. The electronic device of claim 1,
wherein the controller sets device intrinsic information associated with the device information, and
the communicator transmits a control signal comprising the device intrinsic information.

4. The electronic device of claim 1,
wherein the controller sets an IP address as the device intrinsic information associated with the device information, and the communicator transmits a control signal comprising the IP address.

5. The electronic device of claim 1,
wherein the controller sets a control code associated with the device information, and
the communicator transmits a control signal comprising the control code.

6. The electronic device of claim 1, comprising controller for controlling execution of a registration mode,
wherein the storing module stores pieces of registration information each of which comprises: device intrinsic information received from a target device based on communication of the communicator in accordance with execution of the registration mode; and information about direction formed of inclination information indicative of an inclination and direction information indicative of a direction detected by the detector.

7. The electronic device of claim 2,
wherein the storing module stores display information used for displaying an operation screen associated with the target device, and
the controller controls to display an operation screen displayed based on the display information in accordance with settings of the target device.

8. The electronic device of claim 7, comprising displaying module for displaying an operation screen,
wherein the input accepting module accepts an operation input through the operation screen.

9. The electronic device of claim 1,
wherein the storing module stores pieces of registration information each of which comprises device information about each target device, information about direction constituted of inclination information and direction information, and positional information,
the detector detects a first direction from an inclination and a direction of the electronic device and detects a position of the electronic device, and
controller selects one piece of first registration information from the pieces of registration information based on the first direction and the position and sets a first target device based on information about the target device included in the first registration information.

10. The electronic device of claim 1,
wherein the controller controls to display a first operation screen which is displayed based on first display information associated with the first target device.

11. A device control method which is executed by an electronic device to control target devices, the method comprising:
detecting a first direction of the electronic device; and
selecting one piece of first registration information based on the first direction from storing module which stores pieces of registration information each of which comprises information about each target device and information of a direction of each target device, and setting a first target device based on information about the target device included in the first registration information.

12. The device control method of claim 11, further comprising;
transmitting a control signal used for controlling the first target device based on an operation input.

13. The device control method of claim 11, further comprising;
setting device intrinsic information associated with device information, and
transmitting a control signal comprising the device intrinsic information.

14. The device control method of claim 11, further comprising;
setting an IP address as device intrinsic information associated with device information, and
transmitting a control signal comprising the IP address.

15. The device control method of claim 11, further comprising;
setting a control code associated with device information, and
transmitting a control signal comprising the control code.

16. The device control method of claim 11, further comprising;
storing pieces of registration information each of which comprises: device intrinsic information received from a target device based on communication in accordance with execution of a registration mode, and information about direction formed of inclination information indicative of an inclination and direction information indicative of a direction detected by a detector.

17. The device control method of claim 12, further comprising;
storing display information used for displaying an operation screen associated with the target device, and
controlling to display an operation screen displayed based on the display information in accordance with settings of the target device.

18. The device control method of claim 17, further comprising;
displaying an operation screen, wherein an input accepting module accepts an operation input through the operation screen.

19. The device control method of claim 11, further comprising;
storing pieces of registration information each of which comprises device information about each target device, information about direction constituted of inclination information and direction information, and positional information,
detecting a first direction from an inclination and a direction of the electronic device and detecting a position of the electronic device, and
selecting one piece of first registration information from the pieces of registration information based on the first direction and the position and setting a first target device based on information about the target device included in the first registration information.

20. The device control method of claim 11, further comprising;
controlling to display a first operation screen which is displayed based on first display information associated with a first target device.

21. A device control program which is executed by an electronic device that controls target devices, the program allowing the electronic device to execute:
a procedure of selecting one piece of first registration information based on a first direction detection result of the electronic device from storing module which stores pieces of registration information each of which comprises information about each target device and information about a direction of each target device, and setting a first target device based on information about the target device included in the first registration information; and
a procedure of transmitting a control signal which is used for controlling the target device.
